(19) United States
(12) Patent Application Publication
(10) Pub. No.: US 2023/0410035 A1
(43) Pub. Date: Dec. 21, 2023

(54) AUTOMATED STORAGE SYSTEM AND STORAGE SELECTION METHOD

(71) Applicant: Murata Machinery, Ltd., Kyoto-shi, Kyoto (JP)

(72) Inventors: Tsuyoshi Nakano, Inuyama-shi, Aichi (JP); Shigeo Doi, Tokyo (JP)

(21) Appl. No.: 18/031,895

(22) PCT Filed: Sep. 21, 2021
(86) PCT No.: PCT/JP2021/034581

§ 371 Date: Apr. 14, 2023

(30) Foreign Application Priority Data
Oct. 19, 2020 (JP) 2020-175539

(51) Int. Cl. G06Q 10/087; B65G 1/137

(52) U.S. Cl. CPC G06Q 10/087; B65G 1/137

(57) ABSTRACT

A management device includes: a section obtainer that obtains a section to which a load to be carried belongs; a unit obtainer that obtains a unit of handling which refers to a total number of loads to be collectively handled per unit, which belong to a same section; an unfilled subsection determiner that determines an unfilled subsection in which a total number of loads belonging to a same section in each of the automated storages is neither the unit of handling nor a multiple of the unit of handling; and a storage selector that, when there is an unfilled subsection corresponding to the section obtained by the section obtainer, selects, as a destination of the load, one of the automated storages which has the corresponding unfilled subsection.

### TECHNICAL FIELD

This disclosure relates to an automated storage system that includes multiple automated storages and in which handling of loads carried out of the automated storages is predetermined, and a storage selection method applicable to the automated storage system.

### BACKGROUND

In a conventional automated storage system, multiple automated storages are included, and loads carried out of the automated storages are conveyed to a truck berth (see International Publication No. WO 2006/059674, for example).

Unfortunately, when a flow of loads is concentrated on one of the multiple automated storages by the storage state of the loads, the carrying state of the loads out of the automated storages and the like, the allowable workload of the one of the multiple automated storages may be exceeded. In particular, the flow of loads may be suddenly concentrated on one of the multiple automated storages by factors such as the time of day.

It could therefore be helpful to provide an automated storage system in which a destination storage is selected to equalize the flow of loads in automated storages, and a storage selection method.

### SUMMARY

We thus provide an automated storage system including a group of automated storages and a management device that manages storing of a load for the group of automated storages. The management device includes: a section obtainer that obtains a section to which the load to be carried into the group of automated storages belongs; a unit obtainer that obtains a unit of handling which refers to a total number of loads to be collectively handled per unit, which are carried out of the group of automated storages and belong to a same section; an unfilled subsection determiner that determines an unfilled subsection in which a total number of loads belonging to a same section in each of the automated storages is neither the unit of handling nor a multiple of the unit of handling; and a storage selector that, when there is an unfilled subsection corresponding to the section obtained by the section obtainer, selects, as a destination of the load, one of the automated storages which has the corresponding unfilled subsection.

We also provide a storage selection method for use in an automated storage system including a group of automated storages and a management device that manages storing of a load for the group of automated storages. The storage selection method includes: obtaining, by a section obtainer, a section to which the load to be carried into the group of automated storages belongs; obtaining, by a unit obtainer, a unit of handling which refers to a total number of loads to be collectively handled per unit, which are carried out of the group of automated storages and belong to a same section; determining, by an unfilled subsection determiner, an unfilled subsection in which a total number of loads belonging to a same section in each of the automated storages is neither the unit of handling nor a multiple of the unit of handling; and selecting, by a storage selector, when there is an unfilled subsection corresponding to the section obtained by the section obtainer, as a destination of the load, one of the automated storages which has the corresponding unfilled subsection.

It is thus possible to equalize the number of loads to be carried into and out of each of the automated storages, thereby preventing the flow of loads from being concentrated on one of the automated storages.

### BRIEF DESCRIPTION OF THE DRAWINGS

FIG. 1 is a perspective view of an automated storage system.

FIG. 2 is a block diagram illustrating a function unit of a management device.

FIG. 3 is a conceptual diagram illustrating a process of the management device.

FIG. 4 is a flow chart illustrating a processing flow of the management device.

### REFERENCE SIGNS LIST

100 automated storage system
110 group of automated storages
111 first automated storage
112 second automated storage
113 third automated storage
114 fourth automated storage
115 rack
116 first conveyor
117 carrier device
118 vertical conveyor
119 second conveyor
120 third conveyor
121 carry-into vertical conveyor
130 management device
131 section obtainer
132 unit obtainer
133 unfilled subsection determiner
134 storage selector
200 load
210 handling area
211 pallet

### DETAILED DESCRIPTION

The following describes an example of an automated storage system and a storage selection method with reference to the drawings. The examples described below are each one example for the sake of explanation, and therefore not intended to limit the scope of this disclosure. For example, the shapes, configurations, materials, elements, relative positional relationships, connection states, numerical values, numerical expressions, contents of steps in a method, an order of the steps and the like, indicated in the following configurations are mere examples, and contents not described below may be included. Moreover, geometric expressions such as parallel and orthogonal may be used. These expressions do not necessarily provide mathematical strictness, and substantially include allowable errors, offsets or the like. The expressions such as simultaneous and same also substantially include allowable margins.

Moreover, the drawings are schematic illustrations in which emphasis, omission, and ratio adjustment are made where necessary to illustrate our system and methods. Accordingly, the shapes, positional relationships, and ratios of elements are different from the actual shapes, positional relationships, and ratios of the elements.

Moreover, the following may generically describe plural systems and methods as one example. Moreover, a part of the contents described below is explained as optional elements.

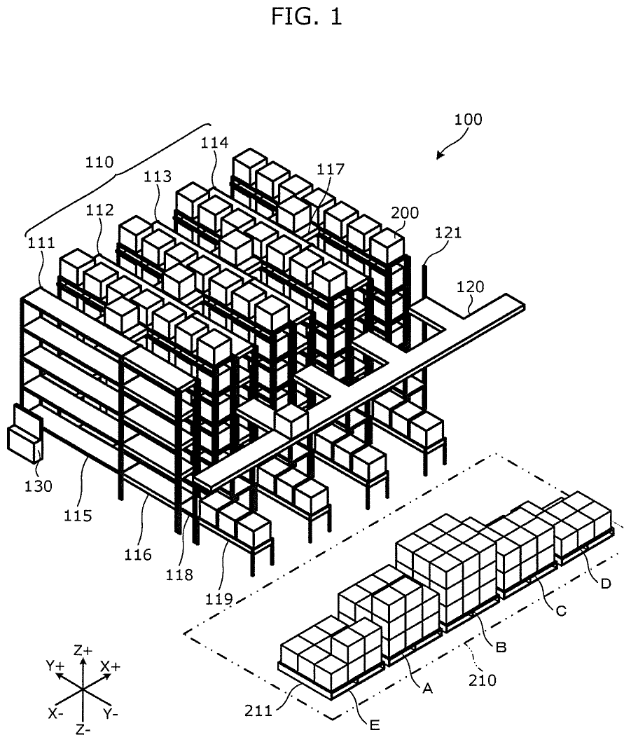

FIG. 1 is a perspective view of an automated storage system. Automated storage system 100 is a system in that loads 200 are automatically carried into and out of storages, and includes group of automated storages 110 and management device 130.

Group of automated storages 110 includes multiple automated storages. In the example, group of automated storages 110 includes, as the automated storages, first automated storage 111, second automated storage 112, third automated storage 113, and fourth automated storage 114. The number of automated storages included in group of automated storages 110 is not limited to this number. Moreover, the types or sizes (the allowable number of stored loads 200) of the automated storages may be different from each other.

Each of the automated storages is a storage for storing loads 200, into and out of which the loads are automatically carried. The types of the automated storages are not particularly limited. Each automated storage includes racks 115, first conveyors 116, carrier device 117, vertical conveyor 118, second conveyor 119, and third conveyor 120.

Each of racks 115 is a shelf for storing loads 200. Each rack 115 includes multiple shelf plates in a vertical direction (the Z-axis direction in FIG. 1), where each of the shelf plates holds loads 200 placed on the shelf plate and aligned in the first direction in a horizontal plane (the Y-axis direction in FIG. 1). Moreover, the automated storage includes two parallel racks 115 between which carrier device 117 is sandwiched in the second direction orthogonal to the first direction in the horizontal plane (the X-axis direction in FIG. 1). The length of rack 115 in the first direction is not particularly limited. In FIG. 1, the length of rack 115 is short. This is for the sake of simplifying the drawing, and thus actual rack 115 may be longer than that of FIG. 1.

Carrier device 117 is a device capable of transferring loads 200 held by racks 115 and first conveyor 116 to different positions in racks 115 and first conveyor 116. The type of carrier device 117 is not particularly limited, and a stacker crane or the like can be taken as an example. Carrier device 117 includes rails each located at a different one of the levels corresponding to the shelf plates of racks 115 and vehicles each provided for a different one of the rails.

Each of the rails extends along rack 115 in the first direction to a corresponding one of first conveyors 116, and each of the vehicles moves back and forth along the corresponding rail with load 200 held by the vehicle. The vehicle includes a transfer device capable of transferring load 200 between the vehicle and rack 115 and also between the vehicle and first conveyor 116. The transfer device can transfer load 200 between the vehicle and any of first conveyor 116 and racks 115 on opposite sides of carrier device 117.

Each of first conveyors 116 is located at a different one of the positions corresponding to the shelf plates of one of racks 115, and conveys load 200 along the first direction, i.e., the extending direction of racks 115, to transfer load 200 to vertical conveyor 118. First conveyor 116 also conveys load 200 transferred from vertical conveyor 118 to a predetermined position in first conveyor 116. The type of first conveyor 116 is not particularly limited, and a roller conveyor, a belt conveyor, or the like can be taken as an example.

Vertical conveyor 118 includes a tray that goes up and down within a range covering the levels of the shelf plates at which first conveyors 116 are located, and vertically conveys load 200 transferred from first conveyor 116 located at a given level to transfer load 200 to second conveyor 119.

Second conveyor 119 conveys load 200 carried out of the automated storage to a predetermined location. Load 200 conveyed by second conveyor 119 is carried by a worker to handling area 210.

Third conveyor 120 is a conveyor for feeding loads 200 to the automated storages. In third conveyor 120, it is possible to select a destination of each of loads 200 from among the automated storages. Third conveyor 120 overlaps with second conveyors 119 in plan view. Third conveyor 120 is located above second conveyors 119 of the automated storages, and has branches such that the end portion of each branch is connected to carry-into vertical conveyor 121 included in each of the automated storages. Third conveyor 120 is managed by management device 130 regarding which automated storage is for load 200 to be carried into.

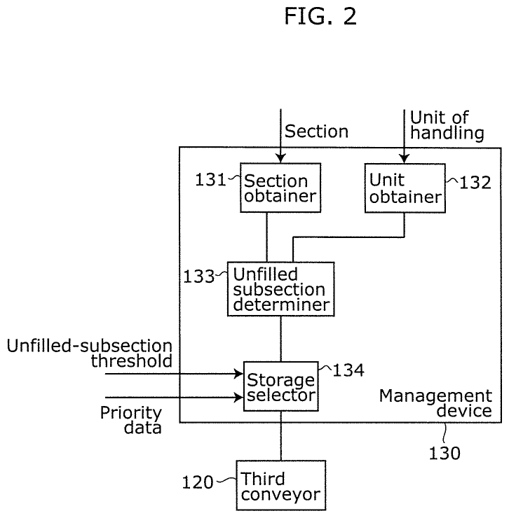

FIG. 2 is a block diagram illustrating a function unit of a management device. Management device 130 is a device for managing storing of loads 200 for group of automated storages 110, and includes section obtainer 131, unit obtainer 132, unfilled subsection determiner 133, and storage selector 134 as processing units that implement functionality by causing a processor included in management device 130 to execute a program.

Section obtainer 131 obtains a section to which each of loads 200 to be carried into group of automated storages 110 by third conveyor 120 belongs, under the condition in which a destination storage is selectable. A source from which section obtainer 131 obtains the section is not particularly limited. For example, the section may be obtained from an upper controller. Moreover, when information indicating the section is attached to load 200, section obtainer 131 may obtain the section using a sensor, a camera, or the like from load 200 before being carried into group of automated storages 110.

The section refers to information for classifying loads 200 into multiple groups. Five pallets are disposed in handling area 210, and load 200 associated with a section for each of pallets 211 is stacked on corresponding pallet 211. More specifically, a worker carries load 200 from second conveyor 119 to pallet 211 in handling area 210, and stacks load 200 on pallet 211 associated with the same section as load 200. In doing so, the worker checks a section associated with load 200 using a monitor provided in the vicinity of second conveyor 119, or the like, and stacks load 200 on pallet 211 associated with the same section.

Handling area 210 is an area where workers, robots or the like perform works such as conveyance of loads 200 and loading of loads 200, and its location, its structure or the like is not particularly limited. For example, handling area 210 is located between a region where pallets 211 on which loads 200 are stacked are disposed and second conveyors 119 of automated storage system 100 and between the region where pallets 211 are disposed and a truck berth where a truck on which pallet 211 with stacked loads 200 is to be loaded waits. Moreover, in handling area 210, means for holding loads 200 such as pallet 211 associated with the section, are arranged (see pallets E through D in FIG. 1).

Unit obtainer 132 obtains a unit of handling which refers to the number of loads 200 to be collectively handled per unit, which are carried out of group of automated storages 110 and belong to the same section. A source from which unit obtainer 132 obtains the unit of handling is not particularly limited. When a worker inputs the unit of handling, obtainment from an upper controller can be taken as an example.

The unit of handling refers to the number of loads 200 to be collectively conveyed from handling area 210 per unit. Loads 200 belonging to the same section in handling area 210 are stacked on pallet 211 and stacked loads 200 are conveyed together with pallet 211, and thus the unit of handling can be regarded as the upper limit of the number of loads 200 stacked on pallet 211. For example, when the upper limit of the number of loads 200 stacked on pallet 211 is 27, the unit of handling is also 27. Note that the unit of handling may be different for each of the sections.

Unfilled subsection determiner 133 determines, for each of the sections, an unfilled subsection in which the number of loads 200 belonging to the same section in each of the automated storages is neither the unit of handling nor a multiple of the unit of handling. The unfilled subsection is information indicating a state in which the number of loads 200 belonging to the same section in one automated storage is neither the unit of handling nor a multiple of the unit of handling. In other words, the unfilled subsection is information indicating a specified section when an insufficient number of loads 200 belonging to the specified section are stored in one automated storage. The insufficient number refers to the number of loads 200 less than the unit of handling or a multiple of the unit of handling.

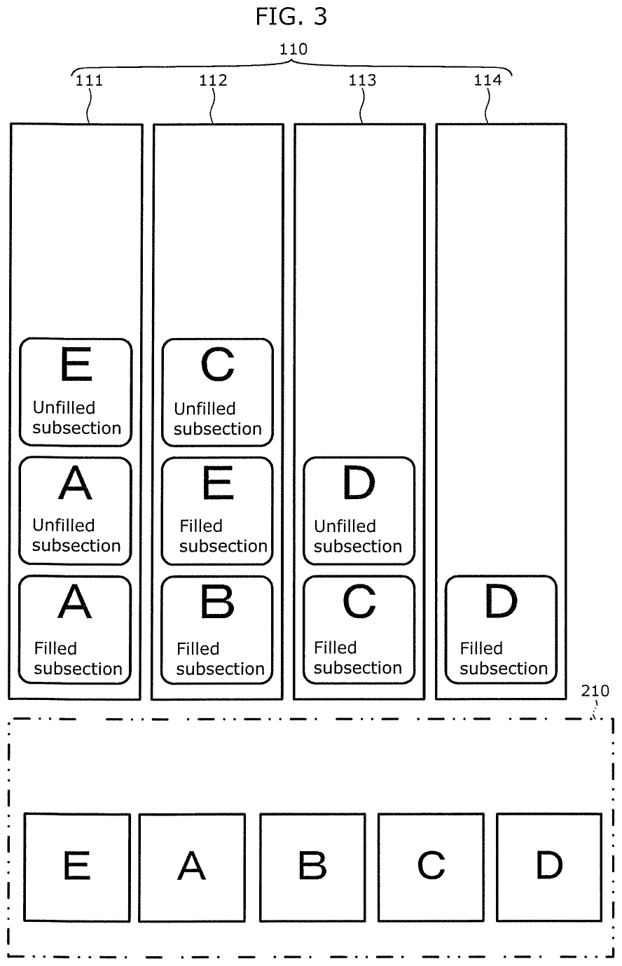

FIG. 3 is a conceptual diagram illustrating a process of management device 130. For example, unfilled subsection determiner 133 counts the number of loads 200 carried into first automated storage 111 and belonging to section A. Furthermore, after first load 200 belonging to section A is carried into first automated storage 111, first load 200 is grouped as belonging to unfilled subsection A. Loads 200 carried one after another and belonging to section A are grouped as belonging to unfilled subsection A until the count reaches the unit of handling. When the number of carried loads 200 belonging to section A reaches the unit of handling, unfilled subsection determiner 133 changes the group of loads from first load 200 to (unit of handling)-th load 200 to a filled subsection A. Furthermore, unfilled subsection determiner 133 resets the count. Unfilled subsection determiner 133 also counts the number of loads 200 carried into first automated storage 111 and belonging to each of section B, section C, section D, and section E, and groups carried loads 200 into unfilled subsection B and filled subsection B, unfilled subsection C and filled subsection C, unfilled subsection D and filled subsection D, and unfilled subsection E and filled subsection E in the same manner as the above. The same is applied to the other automated storages (second automated storage 112, third automated storage 113, and fourth automated storage 114), unfilled subsection determiner 133 counts and groups loads 200 for each of the sections.

When there is an unfilled subsection corresponding to the section obtained by section obtainer 131, storage selector 134 selects, as the destination of load 200, an automated storage having the corresponding unfilled subsection, and outputs the selection to third conveyor 120. For example, in the storage state of loads 200 in group of automated storages 110 as shown in FIG. 3, when load 200 belonging to section A is newly carried into group of automated storages 110, storage selector 134 selects first automated storage 111 as the destination of new load 200 since first automated storage 111 has unfilled subsection A corresponding to section A.

In contrast, when there is no unfilled subsection corresponding to the section obtained by section obtainer 131, storage selector 134 selects an automated storage having the fewest unfilled subsections. For example, in the storage state shown in FIG. 3, when load 200 belonging to section B is newly carried into group of automated storages 110, storage selector 134 selects fourth automated storage 114 having the fewest unfilled subsections as the destination of new load 200 since none of automated storages 110 has unfilled subsection B corresponding to section B.

When there is no unfilled subsection corresponding to the section obtained by section obtainer 131, storage selector 134 may select an automated storage having at most a predetermined unfilled-subsection threshold number of unfilled subsections. For example, for the unfilled-subsection threshold of 1, when load 200 belonging to section B is carried into group of automated storages 110 in the storage state shown in FIG. 3, storage selector 134 can select any one of second automated storage 112, third automated storage 113, and fourth automated storage 114. When there are multiple options as described above, storage selector 134 may obtain, for each of the sections, priority data indicating priority of the automated storages into one of which the load is carried or obtain the priority data in advance, and select an automated storage having high priority and at most a predetermined unfilled-subsection threshold number of unfilled subsections.

For example, the priority data may be data such that the priority is higher with decreasing the distance between an automated storage out of which load 200 is carried and a region of handling area 210 where loads are collectively handled. For example, as to a destination storage of load 200 belonging to section A or section E, the highest priority is given to first automated storage 111. Second automated storage 112, third automated storage 113, and fourth automated storage 114 follow in this order. For section B, the same high priority is given to second automated storage 112 and third automated storage 113, and the same low priority is given to first automated storage 111 and fourth automated storage 114. For section C, the same highest priority is given to third automated storage 113 and fourth automated storage 114. Second automated storage 112 and first automated storage 111 follow in this order. For section D, the highest priority is given to fourth automated storage 114. Third automated storage 113, second automated storage 112, and first automated storage 111 follow in this order.

As described above, in each of the sections, the priority data indicates that the distance to an automated storage assigned with priority and the closeness of the priority have a positive correlation.

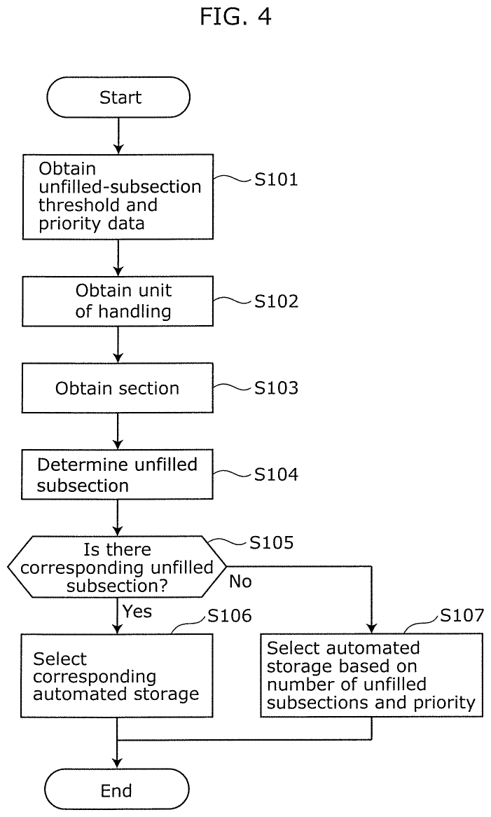

Next, the processing flow of management device 130 is described. FIG. 4 is a flow chart illustrating a processing flow of the management device. First, storage selector 134 obtains the unfilled-subsection threshold and the priority data (S101). Unit obtainer 132 obtains the unit of handling which refers to the number of loads 200 to be collectively handled per unit, which are carried out of group of automated storages 110 and belong to the same section (S102). The unit of handling for each of the sections may be same or different.

Next, before load 200 is carried into group of automated storages 110, section obtainer 131 obtains the section to which this load 200 belongs (S103). Unfilled subsection determiner 133 determines an unfilled subsection in which the number of loads belonging to the same section in each of the automated storages is neither the unit of handling nor a multiple of the unit of handling (S104).

Storage selector 134 determines whether there is an unfilled subsection corresponding to the section obtained by section obtainer 131, and when there is an unfilled subsection corresponding to the section (S105: Yes), storage selector 134 selects an automated storage having the unfilled subsection as the destination storage of load 200 (S106). When there is no corresponding unfilled subsection (S105: No), storage selector 134 selects an automated storage based on the number of unfilled subsections in each automated storage and the priority of automated storages for each of the sections (S107).

With automated storage system 100 according to the example as described above, it is possible to equalize the flow of loads in the automated storages by knowing the unfilled subsection for each of the sections and carrying loads 200 into the automated storages such that the unfilled subsection is generated in each of the automated storages as equal as possible.

Moreover, automated storage system 100 can know the filled subsection, and thus it is possible to easily control the timing of carrying loads 200 out of the automated storage by including an out instruction unit that instructs management device 130 to causes loads 200 included in the filled subsection to be collectively carried out of the automated storage. With this, a worker who conveys loads 200 carried out of the automated storage to handling area 210 can surely stack loads 200 on corresponding pallet 211 one after another.

Our systems and methods are not limited to the example described above. For example, other configurations achieved by optionally combining the elements described in the specification or by excluding some of the elements may be implemented. This disclosure encompasses variations obtained through various modifications made to the above example by those skilled in the art, that is, within the meaning indicated by wordings used in the appended claims.

For example, although the above describes the handling in handling area 210 as collective conveyance of loads 200, the type of handling is not limited to conveyance. For example, loads 200 may be components, and the handling may be collective pairing of the components or collective processing of the components.

Moreover, although the above takes as an example pallet 211 on which loads 200 are stacked in handling area 210, a worker may load loads 200 in a roll box pallet in handling area 210 and operate the roll box pallet to collectively handle loads 200.

Moreover, although the above describes the configurations in which five pallets 211 each associated with a different one of sections are disposed in handling area 210, there may be pallets 211 associated with the same section in handling area 210. Moreover, there may be not a movable component such as pallet 211 or the roll box pallet, but a region associated with a section in a floor surface, a shelf, or the like.

Moreover, the timing for the unfilled-subsection threshold, the priority data, the unit of handling, or the determination of the unfilled subsection is not limited to the order as described above. Any timing is possible.

### INDUSTRIAL APPLICABILITY

Our systems and methods are applicable to an automated storage system that can section and store loads, and carry the loads out of storages when there are different types of collective handling of loads 200.

1-6. (canceled)

7. An automated storage system including a group of automated storages and a management device that manages storing of a load for the group of automated storages, the management device comprising:
a section obtainer that obtains a section to which the load to be carried into the group of automated storages belongs;
a unit obtainer that obtains a unit of handling that refers to a total number of loads to be collectively handled per unit, the loads being carried out of the group of automated storages and belonging to a same section;
an unfilled subsection determiner that determines an unfilled subsection in which a total number of loads belonging to a same section in each of the automated storages is neither the unit of handling nor a multiple of the unit of handling; and
a storage selector that, when there is an unfilled subsection corresponding to the section obtained by the section obtainer, selects, as a destination of the load, one of the automated storages which has the corresponding unfilled subsection.

8. The automated storage system according to claim 7, wherein, when there is no unfilled subsection corresponding to the section obtained by the section obtainer, the storage selector selects one of the automated storages which has fewest unfilled subsections.

9. The automated storage system according to claim 7, wherein, when there is no unfilled subsection corresponding to the section obtained by the section obtainer, the storage selector selects one of the automated storages which has at most a predetermined unfilled-subsection threshold number of unfilled subsections.

10. The automated storage system according to claim 9, wherein the storage selector:
obtains, for each section, priority data indicating priority of the automated storages into one of which the load is carried; and
selects one of the automated storages having a high priority and at most a predetermined unfilled-subsection threshold number of unfilled subsections.

11. The automated storage system according to claim 10, wherein, in each of the sections, closeness of priority in the priority data and a distance to a corresponding one of the automated storages have a positive correlation.

12. A storage selection method for use in an automated storage system including a group of automated storages and a management device that manages storing of a load for the group of automated storages, the storage selection method comprising:
obtaining, by a section obtainer, a section to which the load to be carried into the group of automated storages belongs;
obtaining, by a unit obtainer, a unit of handling that refers to a total number of loads to be collectively handled per unit, the loads being carried out of the group of automated storages and belonging to a same section;
determining, by an unfilled subsection determiner, an unfilled subsection in which a total number of loads belonging to a same section in each of the automated storages is neither the unit of handling nor a multiple of the unit of handling; and
selecting, by a storage selector, when there is an unfilled subsection corresponding to the section obtained by the section obtainer, as a destination of the load, one of the automated storages which has the corresponding unfilled subsection.
